(19) United States
(12) Patent Application Publication
(10) Pub. No.: US 2016/0210159 A1
(43) Pub. Date: Jul. 21, 2016

(54) User Mode Driver Extension and Preprocessing

(71) Applicant: Microsoft Microsoft Technology Licensing, LLC, Redmond, WA (US)

(72) Inventors: Mei L. Wilson, Redmond, WA (US); Jitesh Krishnan, Kirkland, WA (US); Sathyanarayanan Karivaradaswamy, Sammamish, WA (US)

(21) Appl. No.: 14/626,632

(22) Filed: Feb. 19, 2015

Related U.S. Application Data
(60) Provisional application No. 62/105,119, filed on Jan. 19, 2015.

(51) Int. Cl. G06F 9/44; G06F 9/445

(52) U.S. Cl. CPC G06F 9/4411; G06F 9/44505

(57) ABSTRACT

User mode driver extension techniques are described. In one or more implementations, a computing device implements techniques that promote stability of execution of drivers performed by a computing device including stream preprocessing. The computing device includes a processing system to execute an operating system using a kernel mode and a user mode and memory configured to maintain instructions stored thereon that are executable by the processing system. The instructions include the operating system and a device driver and a user mode driver extension that correspond to a camera to support a communicative coupling between the camera and the operating system. The device driver is executable within the kernel mode and the user mode driver extension executable within the user mode. The user mode driver extension is configured to preprocess streams originated by the camera before processing by a camera pipeline of the operating system.

### RELATED APPLICATIONS

This application claims priority to U.S. Provisional Patent Application No. 62/105,119, filed Jan. 19, 2015, and titled “User Mode Driver Extension and Preprocessing,” the entire disclosure of which is hereby incorporated by reference.

### BACKGROUND

Device drivers are used to support a communicative coupling between a device and a computing device. This enables an operating system of the computing device to control and interact with the device without knowing how this access and control is performed through abstraction provided by the device driver. As the complexity and amount of features of the devices has expanded, so too has the complexity of the device drivers used to support interaction with these devices.

Conventional device drivers are executed within a kernel mode of the operating system. Accordingly, failure of conventional device drivers could cause failure of the operating system as a whole, such as due to shared access to memory resources of the operating system by the device driver. Thus, the added complexity of the conventional device drivers to support the expanded functionality of the conventional device drivers could cause the operating system to become unstable. Further, this also limited the device driver to access of functionality of the computing device that is available within the kernel mode.

### SUMMARY

User mode driver extension techniques are described. In one or more implementations, a system is described to implement techniques that promote stability of execution of drivers and include stream preprocessing. The system includes a processing system to execute an operating system using a kernel mode and a user mode and memory configured to maintain instructions stored thereon that are executable by the processing system. The instructions include the operating system having a device pipeline having a plurality of stages, one or more of which are configured to transform a stream of data originated by a device, a device driver that corresponds to the device and is executable within the kernel mode, and a user mode driver extension that is executable within the user mode and that corresponds to the device to support a communicative coupling formed along with the device driver between the device and the device pipeline. The user mode driver extension is configured to preprocess streams originated by the device before processing by the device pipeline.

In one or more implementations, a computing device implements techniques that promote stability of execution of drivers performed by a computing device including stream preprocessing. The computing device includes a processing system to execute an operating system using a kernel mode and a user mode and memory configured to maintain instructions stored thereon that are executable by the processing system. The instructions include the operating system and a device driver and a user mode driver extension that correspond to a camera to support a communicative coupling between the camera and the operating system. The device driver is executable within the kernel mode and the user mode driver extension executable within the user mode. The user mode driver extension is configured to preprocess streams originated by the camera before processing by a camera pipeline of the operating system.

In one or more implementations, a method involves techniques that promote stability of execution of drivers and stream preprocessing. The method includes receiving a stream from a camera at a device driver executed in a kernel mode of an operating system as executed by a computing device, communicating the stream from the device driver executed in the kernel mode to a user mode driver extension executed in a user mode of the operating system of the computing device, preprocessing the stream by the user mode driver extension in the user mode to form a preprocessed stream, and communicating the preprocessed stream from the user mode driver extension to a device pipeline having a plurality of stages to process the preprocessed stream, the plurality of stages including one or more transforms.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion.

FIG. 1 is an illustration of an environment in an example implementation that is operable to employ the user mode driver extension and preprocessing techniques described herein.

FIG. 2 depicts a system in an example implementation showing implementation of the device driver and user mode driver extension in greater detail.

FIG. 3 depicts an example system showing inclusion of a user mode driver extension and device pipeline in a camera context of a capture stack architecture.

FIG. 4 depicts an example implementation showing an architecture of a user mode driver extension of FIG. 3 in greater detail.

FIG. 5 depicts an example implementation showing a sequence diagram for performing a preview that employs a user mode driver extension of FIG. 3 and a device pipeline.

FIG. 6 depicts an example implementation showing a sequence diagram for taking a photo by leveraging a user mode driver extension of FIG. 3 and a device pipeline.

FIG. 7 is a flow diagram depicting a procedure in an example implementation in which user mode driver extension and processing techniques are described

FIG. 8 illustrates an example system including various components of an example device that can be implemented as any type of computing device as described with reference to FIGS. 1-7 to implement embodiments of the techniques described herein.

### DETAILED DESCRIPTION

### Overview

Functionality and complexity of device drivers have increased to address increases in functionality and complexity of corresponding devices. For example, conventional device drivers for cameras typically perform a significant amount of processing of captured data before exposing that captured data (e.g., the images) to other functionality of the computing device, e.g., image processing pipelines, applications, and so forth. By including this functionality within the device driver, however, the processing is performed within a kernel mode in conventional drivers. Accordingly, conventional device driver techniques could increase system instability, make it difficult to maintain the drivers, and limit functionality of the system that is available to the driver.

User mode driver extension and preprocessing techniques are described. In one or more implementations, devices are associated with a device driver and a user mode driver extension. The device driver is executed within a kernel mode of an operating system and the user mode driver extension is executed within a user mode of the operating system. In this way, the user mode driver extension expands functionality of the device driver in the user mode, which increases stability of the device driver and increases functionality made available via the user mode driver extension.

For example, the device driver is configurable as a “thin” device driver having limited functionality and therefore increased stability when executed in the kernel mode. In this way, stability of the operating system and thus a computing device as a whole is increased by limiting complexity of the device driver that operates in the kernel mode. The user mode driver extension, on the other hand, is configured to execute within a user mode and thus failure of the user mode driver extension does not cause failure of the device driver or the operating system. In this way, complex functionality is offloaded to the user mode driver extension, such as to perform preprocessing before providing the data to a device pipeline.

Further, the user mode driver extension is also provided access to functionality in the user mode that is not available via the kernel mode. Examples of this functionality include access to parallel processing, graphics engines, support of a number of output streams that is different a number of input streams, access to Image Signal Processor (ISP) functionality, support out-of-band communication between the user mode driver extension and the device driver, and so forth. In this way, the user mode driver extension increases stability and functionality available to the computing device and device, further discussion of which is described in relation to the following sections and shown in corresponding figures.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

### Example Environment

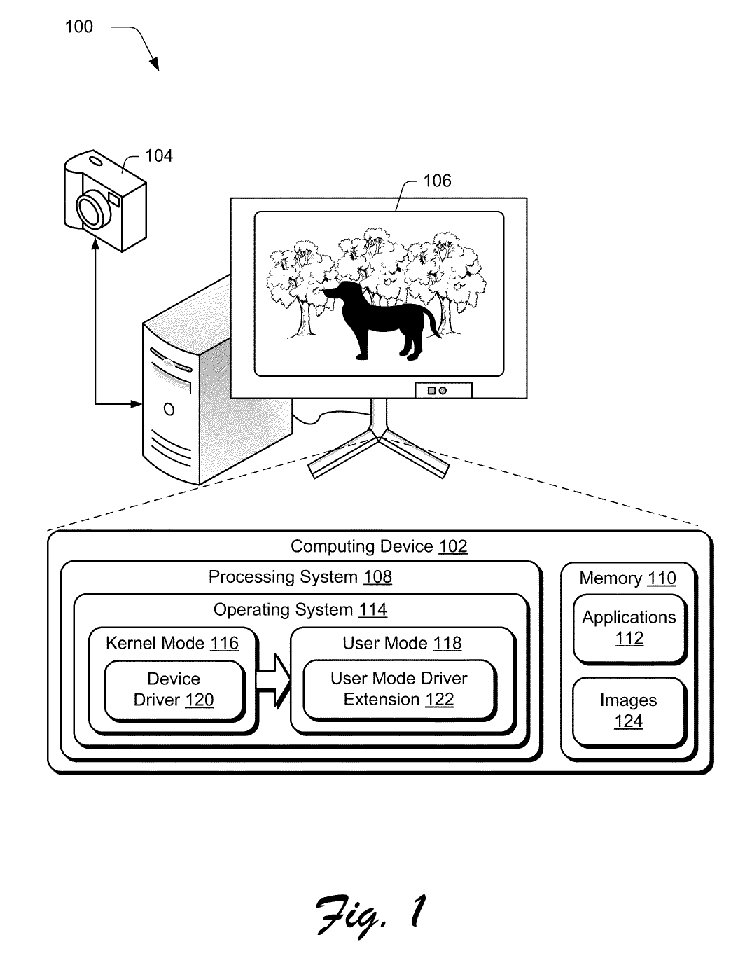

FIG. 1 is an illustration of an environment 100 in an example implementation that is operable to employ the user mode driver extension and preprocessing techniques described herein. The illustrated environment 100 includes an example of a computing device 102, which is illustrated as a desktop PC that is communicatively coupled to a device (e.g., peripheral device), an example of which is illustrated as a camera 104 but other examples are also contemplated, such as three-dimensional printers, audio capture devices, sensors, and so forth. Another example of such a device is illustrated as a display device 106. Although illustrated separately, the device may also be incorporated as an integral part of the computing device 102, such as a tablet configuration having a camera, display device, microphone, and so forth.

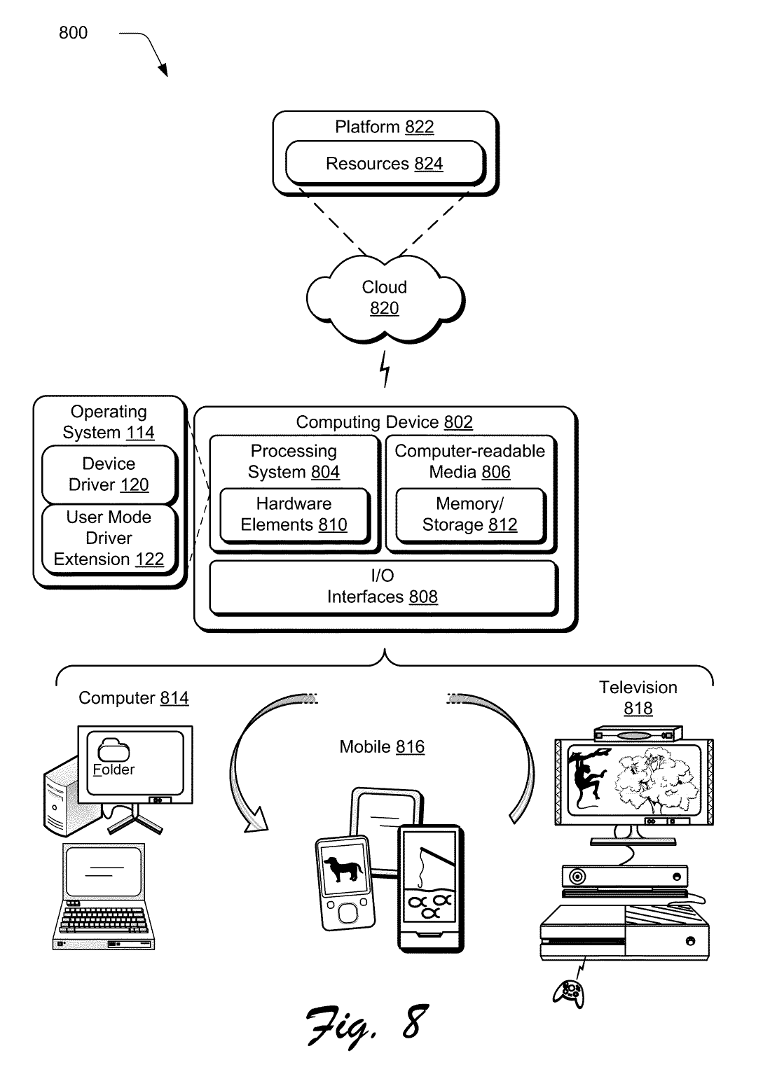

The computing device 102 is configurable in a variety of ways, such as a traditional computer (e.g., a desktop personal computer, laptop computer, and so on), a mobile station, an entertainment appliance, a wireless phone, a tablet, a netbook, and so forth as further described in relation to FIG. 8. Thus, the computing device 102 may range from full resource devices with substantial memory and processor resources (e.g., personal computers, game consoles) to a low-resource device with limited memory and/or processing resources (e.g., traditional set-top boxes, hand-held game consoles). The computing device 102 may also relate to software that causes the computing device 102 to perform one or more operations.

The computing device 102 is also illustrated as including a variety of hardware components, example of which include a processing system 108, and an example of computer-readable storage media, which in this instance is memory 110. The memory 110 is configured to maintain applications 112 and other software that are executable by the processing system 108 to perform one or more operations.

The processing system 108 is not limited by the materials from which it is formed or the processing mechanisms employed therein. For example, the processing system 108 may be comprised of semiconductor(s) and/or transistors (e.g., electronic integrated circuits (ICs)), such as a system on a chip, processors, central processing units, processing cores, functional blocks, and so on. In such a context, executable instructions may be electronically-executable instructions. Alternatively, the mechanisms of or for processing system 108, and thus of or for a computing device, may include, but are not limited to, quantum computing, optical computing, mechanical computing (e.g., using nanotechnology), and so forth. Additionally, although a single memory 110 is shown, a wide variety of types and combinations of memory may be employed, such as random access memory (RAM), hard disk memory, removable medium memory, and other types of computer-readable storage media.

The computing device 102 is further illustrated as including an operating system 114. The operating system 114 is configured to abstract underlying functionality of the computing device 102 to applications 112 that are executable on the computing device 102. For example, the operating system 114 may abstract the processing system 108, memory 110, network, input/output, and/or display functionality of the display device 108, and so on such that the applications 112 may be written without knowing “how” this underlying functionality is implemented. The application 112, for instance, may provide data to the operating system 114 to be rendered and displayed by the display device 104 without understanding how this rendering will be performed. The operating system 114 may also represent a variety of other functionality, such as to manage a file system and user interface that is navigable by a user of the computing device 102.

The operating system 114 includes a kernel mode 116 and a user mode 118. The processing system 108, under control of the operating system 114, switches between these modes depending on a type of code that is being executed. For example, applications 112 are executed in user mode 118 and part of the operating system (e.g., kernel components) are executed in the kernel mode 116.

In order to execute an application 112 in the user mode 118, the operating system 114 creates a process for the application 112. The process provides the application 112 with a private virtual address space and a private handle table. Because an application's 112 virtual address space is private, one application cannot alter data that belongs to another application and thus each application is executed in isolation. Accordingly, if an application 112 crashes, the crash is limited to that application 112 and as such other applications and the operating system 114 are protected from the crash, e.g., continue to execute.

In addition to being private, the virtual address space of the application 112 is limited in the user mode 118. As such, access to virtual addresses that are reserved for the operating system 114 is not permitted from the user mode 118, which prevents applications 112 from altering, and possibly damaging, critical operating system 114 data.

However, an entirety of the code that runs in kernel mode 116 shares a single virtual address space. This means that a device drivers 120 in the kernel mode 120 are not isolated from other drivers and the operating system 114 itself. Consequently, if a conventional device driver accidentally writes to the wrong virtual address, data that belongs to the operating system 114 or another driver may be compromised and if a device driver executed in kernel mode 116 crashes, this may cause the entire operating system 114 to crash.

In the illustrated environment 100, however, functionality is distributed across a device driver 120 that is executed in a kernel mode and a user mode driver extension 122 that is executed in a user mode 118 of the operating system 114. In this way, execution of the user mode driver extension 122 expands functionality available to the device driver 120 while increasing stability of the device driver 120. For example, the device driver 120 is configurable to include functionality that is desired to operate in the kernel mode 116, such as to recognize the camera 104. The user mode driver extension 122 is configured to expand this functionality by leveraging the user mode 118, such as to perform preprocessing of the images 124 before exposure, e.g., for processing by a pipeline and providing to a sink, such as for storage in memory 110, rendering for display on the display device 106, and so on. Further, by implementing functionality of the user mode driver extension 122 in the user mode 118, access is attained to functionality that is not available to the device driver 120 in the kernel mode 116. Further discussion of this and other features are described in the following and shown in a corresponding figure.

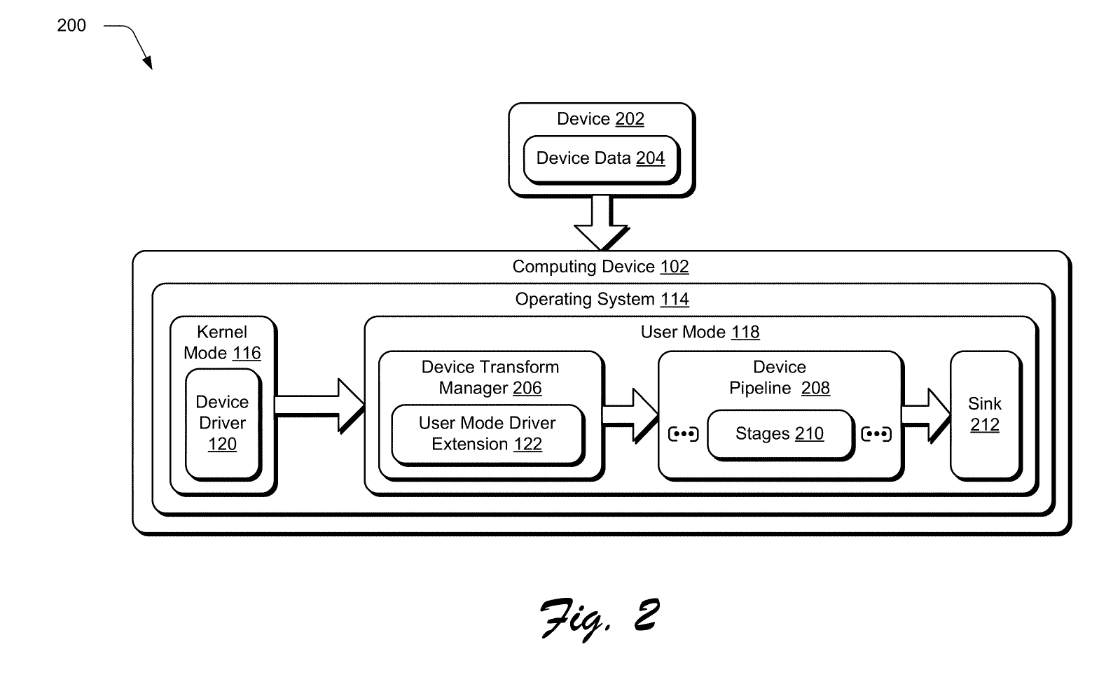

FIG. 2 depicts a system 200 in an example implementation showing implementation of the device driver 120 and user mode driver extension 122 in greater detail. In this example, the device driver 120 and user mode driver extension 122 correspond to a device 202 from a particular manufacturer, e.g., vendor. For example, the manufacturer codes the device driver 120 and the user mode driver extension 122 such that the operating system 114 of the computing device 102 is configured to support communication with the device 202.

The operating system 114 includes a kernel mode 116 and a user mode 118 as previously described such that upon installation the device driver 120 is executed in the kernel mode 116 and the user mode driver extension 122 is executed in the user mode 118. These components, in combination, support communication of processing of device data 204 from the device 202, control of the device 202 by the operating system 114 and/or applications 112 of the computing device 102, and so forth.

The user mode 118 of the operating system 114 is illustrated as including a device transform manager 206. The device transform manager 206 is representation of functionality to manage functionality of the user mode driver extension 112, such as to perform media type negotiation, sample propagation, event handling, and so forth. Further, the device transform manager 206 abstracts the device 202 and driver functionality to a device pipeline 208 and as such represents the device 202 to the device pipeline 208.

The device pipeline 208 includes a plurality of stages 210 that are used to process the device data 204 received from the user mode driver extension 122 via the device transform manager 206. For example, the device pipeline 208 may be part of the operating system 114 that is configured for a particular type of device, such as a camera. In such an example, the stages 210 of the device pipeline 208 include functionality to implement transforms to process the device data 204, which is then output to a sink 212. The sink 212, for instance, may be configured to store a result of processing of the device data 204 in memory 110, render for output by a device (e.g., display by the display device 106, speakers, haptic responses, and so forth), share via a network connection, and so forth.

Thus, in this example the device transform manager 206, device pipeline 208, and sink 212 are provided as part of the operating system 114. The device driver 120 and user mode driver extension 122, on the other hand, are provided along with the device 202 by a device manufacturer, e.g., vendor.

A variety of functionality is supported by leveraging execution of the user mode driver extension 122 in the user mode 118 and the device driver 120 in the kernel mode 116. As previously described, this includes increasing stability of execution of the device driver 120 and user mode driver extension 122 and consequently the operating system 114 and applications 112 of the computing device 102. By shifting functionality for execution as part of the user mode driver extension 122, for instance, a thinner and more compact device driver 120 is usable in kernel mode 116 with reduced complexity. This protects against crashes caused by inclusion of the expanded functionality in the device driver 120. Also, through this bifurcation a crash of the user mode driver extension 122 does not have an effect on execution of the device driver 120 or operating system 114.

Additionally, execution of the user mode driver extension 122 is usable to access functionality in the user mode 118 that not accessible in the kernel mode 116. The user mode driver extension 122, for instance, may employ concurrent processing of a plurality of streams. Additionally, a number of streams received as inputs to the user mode driver extension 122 may be different than a number of streams output by the user mode driver extension. In this way, the user mode driver extension 122 is usable to combine, create, or split incoming streams to produce an arbitrary number of output streams.

The user mode driver extension 122 is also configured to perform preprocessing of the streams before the streams are exposed to the device pipeline 208. This may include performance of transforms before processing by the pipeline. In this way, a manufacturer of the device 202 may provide the user mode driver extension 122 to include functionality that is not otherwise available and do so without compromising stability of the system.

Other functionality is also accessible by the user mode drive extension 122 via the user mode 118 that is not accessible to the device driver 120 via the kernel mode 116. For example, the user mode driver extension 122 may employ parallel processing, have access to Internet Service Provider (ISP) resources, graphics processing engines and units, and so forth. A variety of other examples are also contemplated, further discussion of which is described in relation to the following implementation example involving a camera. Although a camera is described in this example, a variety of other types of devices may leverage the device driver 120 and user mode driver extension 122 techniques described in the following.

Camera User Mode Driver Extension and Device Driver Example

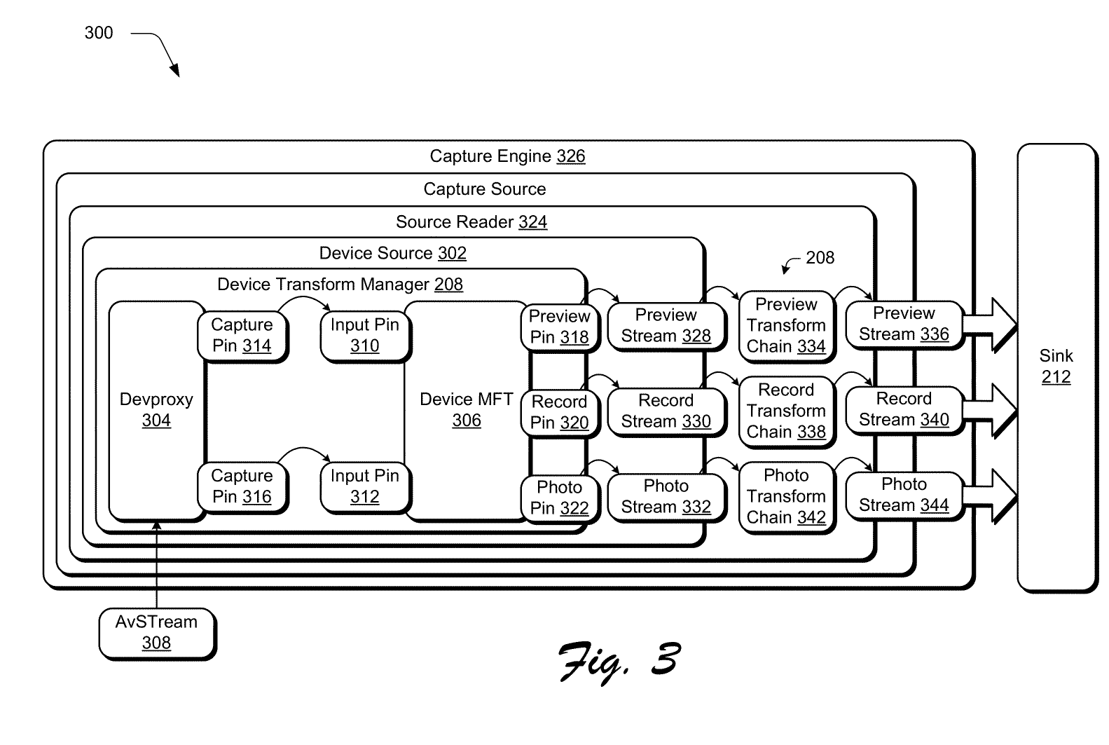

FIGS. 3-6 depict an example implementation in which the user mode driver extension 122 and device driver 120 provide a filter-wide user mode extension to the capture driver. The user mode driver extension 122, through execution in the user mode 118, has access to thread pools, graphics processing units (GPUs) and Internet Service Provider (ISP) resources. The user mode driver extension 122 provides the flexibility of having any number of streams and enables “out of band” communication between the user mode driver extension 122 and device driver 120, which may be used for dedicated metadata and 3^{A} processing streams.

FIG. 3 depicts an example system 300 showing inclusion of the user mode driver extension 122 and device pipeline 208 in a camera context of a capture stack architecture. The device transform manager 208 resides within the device source 302 and manages a devproxy 304 and a device media foundation transform (MFT) 306 (i.e., transform in the following), which corresponds to the user mode driver extension 122 of FIG. 2.

As previously described, the device transform manager 208 is representative of functionality to perform media type negotiation, sample propagation and transform event handling. It also exposes interfaces that device source 302 uses to manage device streams as further described below. The device transform manager 208 abstracts devproxy 304 and device MFT 306 from the device pipeline 208. Accordingly, the device pipeline 208 considers the device MFT 306 as the device and the streams out of the device transform manager 208 as the device streams.

The devproxy 304 is an asynchronous media foundation transform (MFT) that is representative of functionality to marshal the commands and video frames from an AvStream 308 camera driver. This supports “n” number of outputs from the camera driver and owns the allocators for each of the pins exposed by the device 204 of FIG. 2.

The device MFT 306 is the user mode driver extension 122 to the device driver 120, e.g., a capture driver in this example. It is an “m×n” asynchronous transform that is installed on the computing device 102 with the device driver 120 and is provided by the capture driver vendor.

The number of input streams of device MFT 306 (and consequently input pins 310, 312) matches a number of capture pins 314, 316 pins exposed by the device and correspondingly the devproxy 304. The media types supported by the device MFT 306 input streams are the same as the media types exposed by a kernel streaming driver's pins, i.e., device driver 120.

The number of output streams exposed by the device MFT 306 are the streams seen by device source 302 and capture stack, capture application programming interfaces, and applications 112, e.g., one, two, three, and so on. The input and output stream count of the device MFT 306 may be different as previously described. Also, input and output streams may also have different media types, which need not match either. As illustrated, capture pin 314 of the devproxy 304 is associated with input pin 310, capture pin 316 is associated with input pin 312 of the device MFT 306, and so on.

Device MFT 306 is given a pointer to devproxy 306, along with pointers to DX device and MF WorkQueue ID. Frames coming out of the device 202 are fed directly into the corresponding device MFT's 306 input as samples. With each of these, device MFT 306 can post process the captured samples and serve samples to the preview, record and photo pins 318, 320, 322 in this example.

The device pipeline 208, also referred to as a “capture pipeline” or simply “pipeline” in the following, is illustrated as processing three streams, e.g., the preview stream 328, record stream 330, and photo stream 332. Other streams are contemplated, such as a stream supporting a raw data format and so forth. The pipeline includes a plurality of stages including transforms to process these streams, such as a preview transform chain 334 to process a preview stream 328 and output a process preview stream 336, a record transform chain 338 to process a record stream 330 and output a processed record stream 340, and a photo transform chain 342 to process a photo stream 322 and output a processed photo stream 344. Each of the processed streams are output to a sink 212, such as for storage into memory, communication via a network, rendering by a display device 106 or speakers, and so forth.

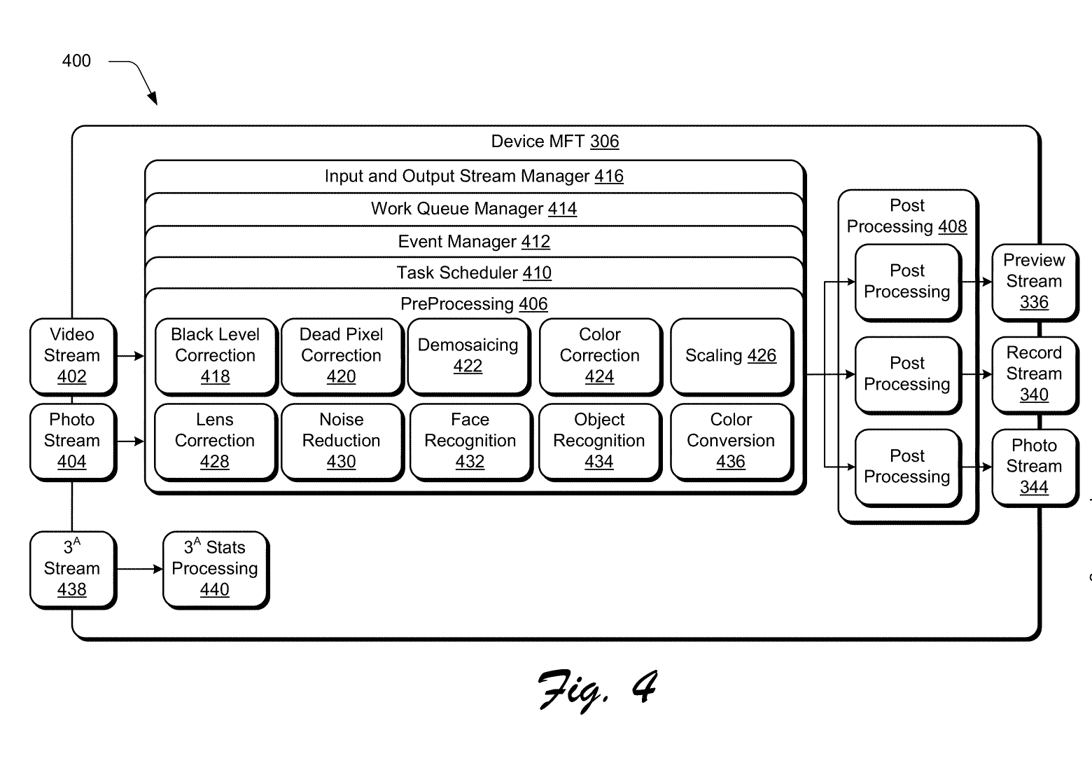

FIG. 4 depicts an example implementation 400 showing an architecture of the device MFT 306 of FIG. 3 in greater detail. The device MFT 306 receives a video stream 402 and a photo stream 404 that are preprocessed by the device MFT 306 before exposure to the device pipeline 208 of FIG. 2, e.g., as a preview stream 336, record stream 340, and photo stream 344 as described in relation to FIG. 3. As such, preprocessing 406 and post processing 408 shown within the device MFT 306 are both still considered preprocessing to the device pipeline 208 as the device MFT 306 (i.e., the user mode drive extension 122) and device transform manager 206 are abstracted to the device pipeline 208 as representing the device 202.

The architecture of the device MFT 306 includes a stack arrangement of preprocessing 406, a task scheduler 410, an event manager 412, a work queue manager 414, and an input and output stream manager 416. A variety of different types of preprocessing 406 may be performed, examples of which include black level correction 418, dead pixel correction 420, demosaicing 422, color correction 424, scaling 426, lens correction 428, noise reduction 430, face recognition 432, object recognition 434, color conversion 436, and so on. The device MFT 306 also includes support for specials streams of metadata, such as a 3^{A} stream 438 to support 3^{A} stats processing 440 as further described below.

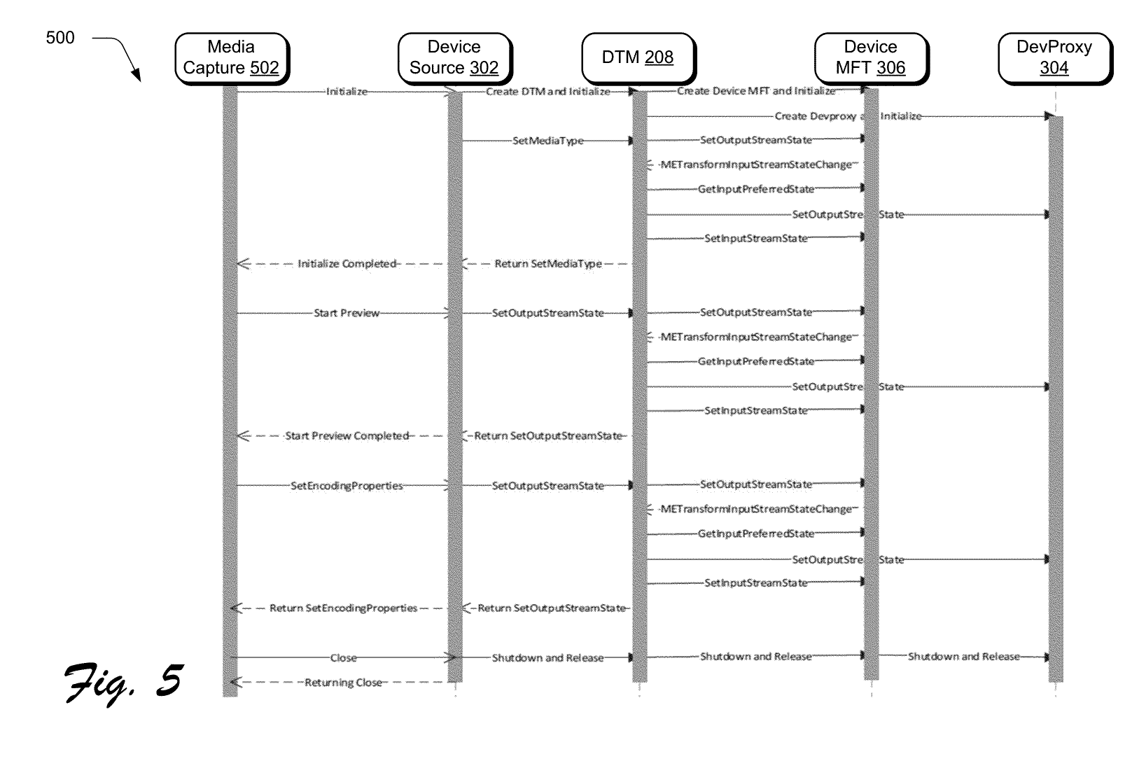

FIG. 5 depicts an example implementation 500 showing a sequence diagram for performing a preview that employs user mode driver extension (e.g., the device MFT 306) and a device pipeline 208 as initiated via media capture 502 and further described below.

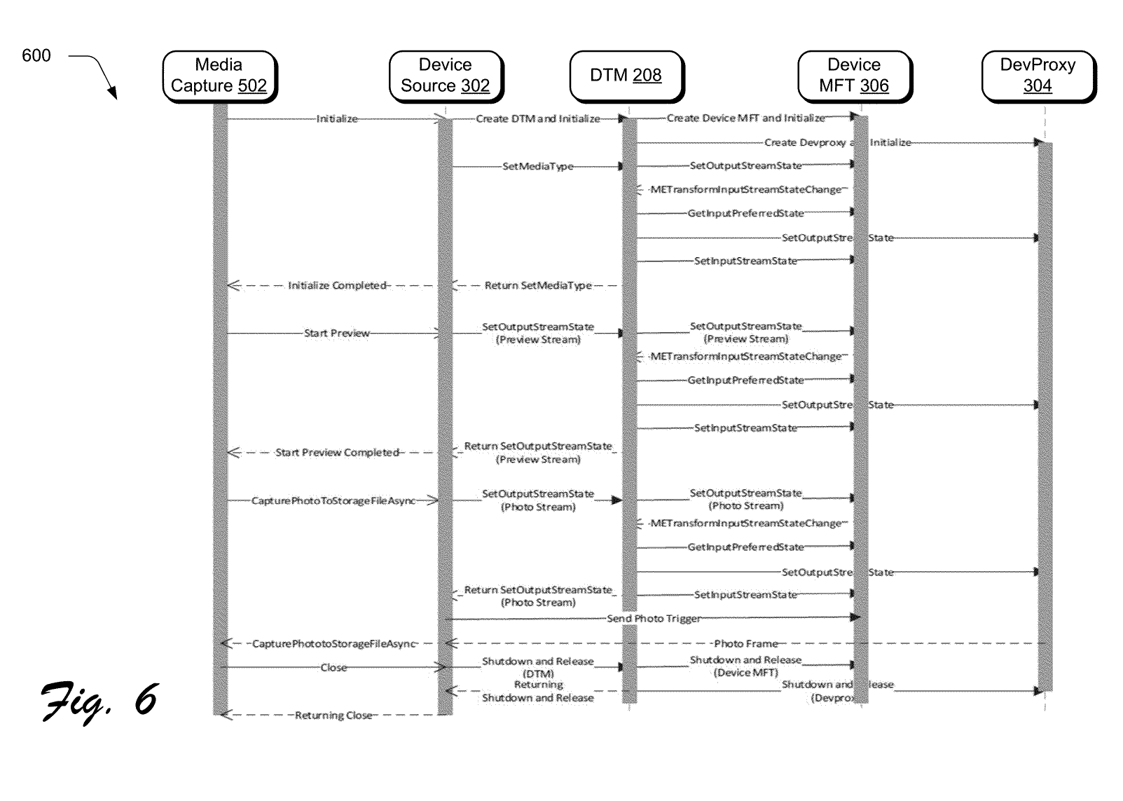

FIG. 6 depicts an example implementation 600 showing a sequence diagram for taking a photo by leveraging user mode driver extension (e.g., the device MFT 306) and a device pipeline 208 as initiated via media capture 502 and further described below.

Return will now be made again to FIG. 3, each of the commands and controls provided for consumption by the device 202 are rerouted to the device MFT 306. The device MFT 306 may then handle the controls or passes it on to the device driver 120 through devproxy 304. This streamlines command handling by the capture driver stack.

On initialization of the capture pipeline, device source 302 instantiates the device transform manager 208, if there is a device MFT 306 for the device. The device source 302 also passes an instance of devproxy 304 that represents the device 202 to the device transform manager's 208 initialization routine. Device transform manager then co-creates the device MFT 306 and performs basic validations. The validations include determination that a number of output pins of devproxy 304 is same as the number of input pins of device MFT 306, support for mandatory interfaces, and so forth.

Device source 302 then queries the device transform manager 208 to obtain the supported output media types. The device transform manager 208 obtains this information from device MFT's 306 output pins. Device source 302 then exposes a presentation descriptor and stream descriptor based on this information to the capture pipeline, e.g., device pipeline 208.

Source reader 324 uses the exposed media types out of the device source 302 and sets the default media types on each stream. In turn, device source 302 sets these default media types on the output streams of the device transform manager 208. The device transform manager 208 sets this media type on the output stream of the device MFT 306, e.g., using a “SetOuputStreamState( )” function.

When “SetOutputStreamState( )” is called, device MFT 306 posts a message to device transform manager 208 to change its input stream's media type based on the selected output media type and waits. In response to this message, device transform manager 208 queries the preferred input media type for the input stream of the device MFT 306, e.g., using “GetPreferredInputStreamState( )” and sets this media type on the corresponding output stream of devproxy 304. If that succeeds then the device transform manager 208 sets that same media type on to the device MFT's 306 input stream using “SetInputStreamState( )” After receiving this call, device MFT 306 completes “SetOutputStreamState( ).”

Capture engine 326 selects individual streams by enabling specific streams on device source 302. This is propagated to device MFT 306 by the device transform manager 208 through “SetOutputStreamState( )” call. Device MFT 306 places the specific output streams in the requested state. As mentioned above, device MFT 306 also notifies the device transform manager 208 about the input streams that are to be enabled. This results in the device transform manager 208 propagating the stream selection to devproxy 304. At the end of this process, each of the streams, in devproxy 304 and the device MFT 306 are ready to stream.

Source reader 324 then starts the device source 302 when capture engine 326 calls “ReadSample.” In turn, device source 302 starts the device transform manager 208 by sending “MFT_MESSAGE_NOTIFY_BEGIN_STREAMING” and “MFT_MESSAGE_NOTIFY_START_OF_STREAM” messages indicating the start of the pipeline 208. Device transform manager 208 starts devproxy 304 and the device MFT 306 by propagating “MFT_MESSAGE_NOTIFY_BEGIN_STREAMING” and “MFT_MESSAAGE_NOTIFY_START_OF_STREAM” messages.

Device transform manager 208 calls “SetOutputStreamState” on the device MFT's 306 outputs with the streaming state parameter. Device MFT 306 then starts streaming in those streams. Device transform manager 208 also starts the streaming on devproxy 304 output streams that have a valid media type set. Devproxy 304 allocates the samples and fetches them from the device 202. These samples are fed into the device MFT 306 in the relevant input pin. Device MFT 306 processes these samples and gives the output to device source 302. From device source 302, the samples flow through source reader 324 to capture engine 326.

Capture engine 326 stops individual streams by disabling individual stream through an internal interface on device source 302. This is translated into specific output stream disabling on device MFT 306 through “SetOutputStreamState( )” In turn, device MFT 306 makes a request to disable specific input streams through a “METransformInputStreamStateChanged” event. Device transform manager 208 then propagates this to a corresponding devproxy stream.

As long as the device MFT 306 is in a streaming state, the device MFT 306 can request any input stream to transition to any of the valid “DeviceStreamState,” i.e., it could send it to “DeviceStreamState_Stop” or “DeviceStreamState_Run” or “DeviceStreamState_Pause” and so on without affecting other streams.

However, the output stream transition is controlled by capture pipeline 208, e.g., the preview, record and photo streams in the illustrated example are enabled or disabled by the capture pipeline 208. Even when the outputs are disabled, any input stream may still stream as long as the device MFT 306 itself is in a streaming state.

The device MFT 306 (i.e., the user mode driver extension 122) is loaded after a corresponding kernel stream driver (e.g., device driver 120) is created and is unloaded before kernel stream driver is closed. From a standpoint of the pipeline 208, when the device source 302 is created the device MFT 306 is created and when the device source 302 is shutdown the device MFT 306 is shutdown synchronously. To support shutdown, the device MFT 306 supports an “IMFShutdown” interface. After device MFT 306 shutdown is called, any other interface call into the device MFT 306 is returned an “MF_E_SHUTDOWN” error.

Frames can be captured into a variety of different memory buffers per the preference of device driver 120. Whatever buffer that comes out of the camera driver is directly fed into the device MFT 306 for further processing. Additionally, devproxy 304 allocates the buffers based on driver's preference. As such, the device MFT 306 makes use of allocator APIs to allocate samples used for its output pins for non-in place transforms.

Clients of source reader 324 are able to see the media types exposed by the device MFT's 306 output streams as the natively supported media types. When the native media type is changed, source reader 324 sends media type notification calls into the device MFT 306 through device source 302. It is the responsibility of the device MFT 306 to flush each of the pending samples from that stream's queue and switch to the new media type on that stream in a timely manner. If there is a desire to change the input media type then the device MFT 306 changes the current input media type to that one. Device transform manager 208 gets the current media type from the input stream of the device MFT 306 and sets it on the devproxy's 304 output streams and the device MFT's 306 input after each native media type change.

Since the device MFT 306 is a “m×n” transform, there are possible repercussions on input streaming pin's media types and state change when output streaming pin's media types or state changes. For example, on output media type changes, e.g., when an application 112 changes a native media type that would percolate through the capture stack into the device MFT 306 as an output pin media type change. In another example, when output media type changes could trigger an input media type change. For instance, each of the output pins may stream at 720p. This would have resulted in streaming from camera at 720p. However, suppose the record stream changes its native media type to 1080p. Now one of the device MFT 306 input streams that was fetching data to the record stream has to change its media type. In a further example, when an output pin is disabled, such as when an application 112 disables one of device MFT 306 outputs when the same input is shared by more than one outputs, for optimization sake the input may have to change the media type. For instance, if a 1080p output stream stops and each the other streams, sharing one input, are streaming at 720p then the input stream changes its media type to 720p to save power and performance. The device transform manager 308 handles “METransformInputStreamStateChanged” notifications from device MFT 306 to change the media type and or state on device MFT 306 input and devproxy 304 output under these conditions.

Two types of flushing may be performed as part of managing the device MFT 306. A global flush, for instance, may happen when the device transform manager 208 is about to send stop streaming message to the device MFT 306. The device MFT 306 drops each of the samples from its input and output queues and returns synchronously and does not ask for new input or send notification on new available output. For a local flush, such as for an output pin specific flush, this happens when a stream is stopped.

In order to perform a photo trigger, instead of sending the photo trigger and photo sequence start and stop triggers directly to the device driver 120, the triggers are instead re-routed to the device MFT 306. The device MFT 306 handles the trigger or forwards it to the device driver 120 as desired.

In one or more implementations, a device source 302 may initiate a warm start for specific output streams by transitioning the stream to a pause state. In turn, the device transform manager 208 calls “SetOutputStreamState( )” on device MFT 306 to transition a specific output stream to pause state. This results in a corresponding input stream to be put into a pause state and is achieved by the device MFT 306 by requesting “METransformInputStreamStateChanged” to the device transform manager 208 and handling “SetInputStreamState( ).”

A variable photo sequence is also supported using the device driver 120 and user mode driver extension 122, e.g., a camera device driver and device MFT 306. This reduces the complexity of the device driver 102, as the start and stop photo sequence triggers are sent to the device MFT 306, which can handle the photo sequence with less difficulty than the device driver 120, itself.

Devproxy 304 queries the device driver 120 (i.e., kernel streaming driver) for metadata buffer size and allocates the memory for metadata. Metadata coming from device driver 102 is set by devproxy 304 on the sample. Device MFT 306 consumes this sample metadata and may either pass it on with the sample through its output stream or use it for post processing.

Since device MFT 306 supports any number of inputs, a dedicated input pin may be dedicated for use to communicate metadata or out of band metadata. The media type for this pin is custom and the device driver 120 decides the size and number of buffers.

This metadata stream is not exposed beyond the device transform manager 208. The stream is put into streaming state when device MFT 306 starts streaming, i.e., when output streams are selected for streaming, device MFT 306 requests that the device transform manager 208 starts one or more video stream and the metadata stream as well using a “METransformInputStreamStateChanged” event. Note, as the number of input pins may be different that a number of output pins in this implementation, there could be a separate pin dedicated for the metadata or 3^{A}.

Device Transform Manager Event Handling

The following sections include examples of event handling for the device transform manager 208.

METransformHaveOutput Event

This event indicates that a device transform has a sample ready on one of its output stream. The event is sent when devproxy 304 or the device MFT 306 have a sample ready on an output stream to be picked up by the device transform manager 208.

When Devproxy raises “METransformHaveOutput,” the device transform manager 208 calls “ProcessOutput” on devproxy 304. The resulting samples are fed into the device MFT's 306 corresponding input.

When device MFT 306 raises “METransformHaveOutput,” the device transform manager 208 relays the event to device source 302. The device source 302 calls “ProcessOutput” on the device transform manager 208, which is routed to the device MFT 306. Thus, the sample is picked up by device source 302 and enters the media pipeline.

Device MFT 306 receives the total output stream count of “MFT_OUTPUT_DATA_BUFFER” structures in an array. It is expected to fill in the structure members with appropriate values. Before the device transform manager 208 calls back into the device MFT 306 to retrieve a sample, e.g., in response to a “METransformHaveOutput” message, if another sample becomes available for another stream, device MFT 306 sends the sample in this “ProcessOutput” call. The device transform manager 208 then calls “ProcessOutput” again, but at that time, device MFT 306 return the call without samples if none are available.

METransformNeedInput Event

Indicates that a device transform desires an input. This even is sent when a device transform needs an input to generate output. Typically, asynchronous transforms use this message to get input samples for processing and produce an output sample. For parameters, input stream index is sent in an “IMFMediaEvent's” attribute store as “MF_EVENT_MFT_INPUT_STREAM_ID.” This event is not be handled by device transform manager 308 because devproxy 304 does not have input pins and even though Device MFT has input pins, it is automatically fed with samples when available on the output of devproxy 304. Hence there is no need for device MFT 306 to request for samples and such a request would thus be ignored by the device transform module 208.

METransformInputStreamStateChanged

This event indicates that the input stream's state and/or media type are to be changed. When device MFT's 306 output is changed, related input stream's state are changed. When this condition arises, device MFT generates 306 a “METransformInputStreamStateChanged” event.

In response to this event, the device transform manager 208 calls GetInputStreamPreferredState on the device MFT 306 with the specified input stream index. Device MFT 306 returns the preferred state and media type. The device transform manager 208 sets the requested media type on devproxy's 304 output stream first and transitions it to the requested streaming state. If that succeeds then the device transform manager 208 sets the same media type on the device MFT's 306 input stream and transitions it to the requested state.

If there is an error during this process then “SetInputStreamState's dwStatus” parameter contains the error that occurred. Device MFT 306 propagates the error to the device transform manager 208 as appropriate.

This event may be generated when the specified stream is in stopped or running state. If the stream is in stopped state, the device transform manager 208 queries the preferred type for that device MFT 306 input stream and sets it on the output of devproxy 304. If that is successful, then the device transform manager 208 sets the same preferred media type on the input of the device MFT 306.

When device MFT 306 generates this event is while streaming, further sample delivery is stopped and a preferred media type is requested on the device MFT's 306 input. This media type is set on the output of devproxy 304 and input of device MFT 306. The stream is automatically restarted on devproxy's 304 output stream and the samples are delivered to the device MFT's 306 input stream. When new samples arrive, device MFT 306 delivers the samples to the related output streams.

METransformFlushInputStream Event

This event informs the device transform manager 208 to flush the output stream of devproxy that is connected to the input of device MFT 306. This is used when a specific output of device MFT 306 is flushed, the corresponding input of device MFT 306 and the connected devproxy 304 stream are flushed.

When device MFT's 306 output is changed or flushed, related input stream may be flushed and as such when this condition arises, device MFT 306 generates this event.

When device MFT's 306 input stream's connected stream is to be flushed, it generates this event. In response to this event, the device transform manager 208 calls “FlushOutputStream” on the connected stream of the devproxy 304 and it calls “FlushInputStream” on the device MFT 306. Device MFT 306 flushes its input stream and the flush operation is considered complete. In general this event is called when the stream itself is in running state or about to be stopped.

Interface “IMFDeviceTransform”

This interface supports interaction with the device MFT 306 and facilitates management of the “m” input and “n” output device MFT 306. An example of such an interface is described in the following:

interface IMFDeviceTransform : IUnknown
{

HRESULT InitializeTransform(

[in, annotation(“_In_”)] IMFAttributes* pAttributes
);

HRESULT GetInputAvailableType(

[in, annotation(“_In_”)] DWORD dwInputStreamID,
[in, annotation(“_In_”)] DWORD dwTypeIndex,
[out, annotation(“_COM_Outptr”)] IMFMedia type** pMedia type
);

HRESULT GetInputCurrentType(

[in, annotation(“_In_”)] DWORD dwInputStreamID,
[out, annotation(“_COM_Outptr”)] IMFMedia type** pMedia type
);

HRESULT GetInputStreamAttributes(

[in, annotation(“_In_”)] DWORD dwInputStreamID,
[out, annotation(“_COM_Outptr_”)] IMFAttributes** ppAttributes
);

HRESULT GetOutputAvailableType(

[in, annotation(“_In_”)] DWORD dwOutputStreamID,
[in, annotation(“_In_”)] DWORD dwTypeIndex,
[out, annotation(“_COM_Outptr”)] IMFMedia type** pMedia type
);

HRESULT GetOutputCurrentType(

[in, annotation(“_In_”)] DWORD dwOutputStreamID,
[out, annotation(“_COM_Outptr”)] IMFMedia type** pMedia type
);

HRESULT GetOutputStreamAttributes(

[in, annotation(“_In_”)] DWORD dwOutputStreamID,
[out, annotation(“_COM_Outptr_”)] IMFAttributes** ppAttributes
);

HRESULT GetStreamCount(

[out, annotation(“_Out_”)] DWORD* pcInputStreams,
[out, annotation(“_Out_”)] DWORD* pcOutputStreams
);

HRESULT GetStreamIDs(

[in, annotation(“_In_”)] DWORD dwInputIDArraySize,
[out, annotation(“_Out_”)] DWORD* pdwInputStreamIds
[in, annotation(“_In_”)] DWORD* dwOutputIDArraySize,
[out, annotation(“_Out_”)] DWORD* pdwOutputStreamIds
);

HRESULT ProcessEvent(

[in, annotation(“_In_”)] DWORD dwInputStreamID,
[in, annotation(“_In_”)] IMFMediaEvent* pEvent
);

HRESULT ProcessInput(

[in, annotation(“_In_”)] DWORD dwInputStreamID,
[in, annotation(“_In_”)] IMFSample* pSample,
[in, annotation(“_In_”)] DWORD dwFlags
);

HRESULT ProcessMessage(

[in, annotation(“_In_”)] MFT_MESSAGE_TYPE eMessage,
[in, annotation(“_In_”)] ULONG_PTR ulParam
);

HRESULT ProcessOutput(

[in, annotation(“_In_”)] DWORD dwFlags,
[in, annotation(“_In_”)] DWORD cOutputBufferCount,
[inout, annotation(“_Inout_”)] MFT_OUTPUT_DATA_BUFFER*

pOutputSample,

[out, annotation(“_Out_”)] DWORD* pdwStatus
);

HRESULT SetInputStreamState(

[in, annotation(“_In_”)] DWORD dwStreamID,
[in, annotation(“_In_”)] IMFMedia type *pMedia type,
[in, annotation(“_In_”)] DeviceStreamState value,
[in, annotation(“_In_”)] DWORD dwStatus
);

HRESULT GetInputStreamState(

[in, annotation(“_In_”)] DWORD dwStreamID,
[out, annotation(“_Out_”)] DeviceStreamState *value
);

HRESULT SetOutputStreamState(

[in, annotation(“_In_”)] DWORD dwStreamID,
[in, annotation(“_In_”)] IMFMedia type *pMedia type,
[in, annotation(“_In_”)] DeviceStreamState value,
[in, annotation(“_In_”)] DWORD dwFlags
);

HRESULT GetOutputStreamState(

[in, annotation(“_In_”)] DWORD dwStreamID,
[out, annotation(“_Out_”)] DeviceStreamState *value
);

HRESULT GetInputStreamPreferredState(

[in, annotation(“_In_”)] DWORD dwStreamID,
[out, annotation(“_Out_”)] DeviceStreamState *value,
[out, annotation(“_COM_Outptr_”)] IMFMedia type** ppMedia type
);

HRESULT FlushInputStream(

[in, annotation(“_In_”)] DWORD dwStreamIndex,
[in, annotation(“_In_”)] DWORD dwStatus
);

HRESULT FlushOutputStream(

[in, annotation(“_In_”)] DWORD dwStreamIndex,
[in, annotation(“_In_”)] DWORD dwFlags
);

};

IMFDeviceTransform::InitializeTransform

This function is called to initialize the device MFT 306, and has the following syntax:

HRESULT InitializeTransform(

_In_opt_MFAttributes* pAttributes
);

and includes the following parameters “pAttributes [_In_opt_]” and optionally contains a pointer to an attribute, passed in by the capture pipeline that contains initialization parameters.

The method returns an “HRESULT.” Possible values include but not limited to values given in the following table.

| Return code | Description |
|---|---|
| S_OK | Initialization succeeded |
| MF_E_INVALIDREQUEST | Device MFT couldn't support |
| | the request at this time. |

Device MFTs 306 can take advantage of this function to initialize various internal objects and states. Pipeline 208 can also use the input “IMFAttributes” parameter to communicate certain configuration information to the device MFT 306.

IMFDeviceTransform::GetInputAvailableType Method

This method gets an available media type for an input stream on this media foundation transform (MFT) and has the following syntax:

HRESULT GetInputAvailableType(

_In_ DWORD dwInputStreamID,

_In_ DWORD dwTypeIndex,
_COM_Outptr_ IMFMediaType** pMediaType
);

The method also includes these parameters: “dwInputStreamID [_In_],” which is an input stream identifier used to get the list of stream identifiers, call “IMFDeviceTransform::GetStreamIDs;” “dwTypeIndex [_In_]” which is an index of the media type to retrieve, Media types are indexed from zero and returned in approximate order of preference; and “pMediaType [_COM_Outptr_]” which receives a pointer to the IMFMediaType interface.

The method returns an HRESULT. Possible values include but not limited to values given in the following table.

| Return code | Description |
|---|---|
| S_OK | Initialization succeeded |
| MF_E_INVALIDREQUEST | Device MFT couldn't support |
| | the request at this time. |
| MF_E_INVALIDSTREAMNUMBER | The stream ID is not valid |
| MF_E_NO_MORE_TYPES | There is no media type |
| | available with the |
| | specified index |

The transform defines a list of available media types for each input stream and orders them by preference. This method enumerates the available media types for an input stream. To enumerate the available types, increment “dwTypeIndex” until the method returns “MF_E_NO_MORE_TYPES.”

If the device MFT 306 stores a media type internally, the device MFT 306 returns a clone of the media type, not a pointer to the original type. Otherwise, the caller might modify the type and alter the internal state of the device MFT 306.

IMFDeviceTransform::GetInputCurrentType Method

The method gets the current media type for an input stream on this transform, and has the following syntax:

HRESULT GetInputCurrentType(

_In_ DWORD dwInputStreamID,
_COM_Outptr_ IMFMediaType** pMediaType
);

and the following parameters “dwInputStreamID [_In_]” which is an input stream identifier, to get the list of stream identifiers, call “IMFDeviceTransform::GetStreamIDs;” and “pMediaType [_COM_Outptr_]” which receives a pointer to the “IMFMediaType” interface that represents the current type used by that stream.

The method returns an HRESULT. Possible values include but not limited to values given in the following table.

| Return code | Description |
|---|---|
| S_OK | Initialization succeeded |
| MF_E_INVALIDREQUEST | Device MFT couldn't |
| | support the request at |
| | this time. |
| MF_E_INVALIDSTREAMNUMBER | The stream ID is not valid |
| MF_E_NO_MORE_TYPES | There is no media type |
| | available with the |
| | specified index |
| MF_E_TRANSFORM_TYPE_NOT_SET | No media type has been |
| | set yet. |

If the specified input stream does not yet have a media type, the method returns “MF_E_TRANSFORM_TYPE_NOT_SET.” The transform returns a clone of the media type, not a pointer to the original type. Otherwise, the caller might modify the type and alter the internal state of the transform.

IMFDeviceTransform::GetInputStreamAttributes Method

The method gets the attribute store for an input stream on the transform, and has the following syntax:

HRESULT GetInputStreamAttributes(

_In_ DWORD dwStreamID,
_COM_Outptr_ IMFAttributes** ppAttributes,
);

and the following parameters: “dwStreamId [_In_]” which is a stream ID of the input stream whose state is to be retrieved; and “ppAttributes [_COM_Outptr_]” which receives a pointer to the “IMFAttributes” interface. The interface is released by the caller.

The method returns an “HRESULT.” Possible values include but not limited to values given in the following table.

| Return code | Description |
|---|---|
| S_OK | Transitioning the stream state |
| | succeeded |
| MF_E_INVALIDREQUEST | Device MFT couldn't support |
| | the request at this time. |
| MF_E_INVALIDSTREAMNUMBER | When an invalid stream ID is |
| | passed |

This function is used by the device transform manager 208 to get a specific input stream's attribute store.

IMFDeviceTransform::GetOutputAvailableType Method

This method gets an available media type for an output stream on this transform and has the following syntax:

HRESULT GetOutputAvailableType(

_In_ DWORD dwOutputStreamID,
_In_ DWORD dwTypeIndex,
_COM_Outptr_ IMFMediaType** pMediaType
);

and the following parameters “dwOutputStreamID [_In_]” which is an output stream identifier, to get the list of stream identifiers, call “IMFDeviceTransform::GetStreamIDs;” “dwTypeIndex [_In_]” which is an index of the media type to retrieve, media types are indexed from zero and returned in approximate order of preference; and “pMediaType [_COM_Outptr_]” which receives a pointer to the “IMFMediaType” interface.

The method returns an HRESULT. Possible values include but not limited to values given in the following table.

| | |
|---|---|
| S_OK | Initialization succeeded |
| MF_E_INVALIDREQUEST | Device MFT couldn't support |
| | the request at this time. |
| MF_E_INVALIDSTREAMNUMBER | The stream ID is not valid |
| MF_E_NO_MORE_TYPES | There is no mediatype |
| | available with the |
| | specified index |

The transform defines a list of available media types for each output stream and orders them by preference. This method enumerates the available media types for an output stream. To enumerate the available types, increment “dwTypeIndex” until the method returns “MF_E_NO_MORE_TYPES.” If the transform stores a media type internally, the transform returns a clone of the media type, not a pointer to the original type. Otherwise, the caller might modify the type and alter the internal state of the transform.

IMFDeviceTransform::GetOutputCurrentType Method

The method gets the current media type for an output stream on this transform and has the following syntax:

HRESULT GetOutputCurrentType(

_In_ DWORD dwOutputStreamID,
_COM_Outptr_ IMFMediaType** pMediaType
);

and the following parameters: “dwOutputStreamID [_In_]” which is an output stream identifier, to get the list of stream identifiers, call “IMFDeviceTransform::GetStreamIDs;” and “pMediaType [_COM_Outptr_]” which receives a pointer to the “IMFMediaType” interface that represents the current type used by that stream.

The method returns an HRESULT. Possible values include but not limited to values given in the following table.

| Return code | Description |
|---|---|
| S_OK | Initialization succeeded |
| MF_E_INVALIDREQUEST | Device MFT couldn't |
| | support the request |
| | at this time. |
| MF_E_INVALIDSTREAMNUMBER | The stream ID is not valid |
| MF_E_NO_MORE_TYPES | There is no mediatype |
| | available with |
| | the specified index |
| MF_E_TRANSFORM_TYPE_NOT_SET | No mediatype |
| | has been set yet. |

If the specified output stream does not yet have a media type, the method returns MF_E_TRANSFORM_TYPE_NOT_SET. The transform returns a clone of the media type, not a pointer to the original type. Otherwise, the caller might modify the type and alter the internal state of the transform.

IMFDeviceTransform::GetOutputStreamAttributes Method

This method gets the attribute store for an output stream on this transform and has the following syntax:

HRESULT GetOutputStreamAttributes(

_In_ DWORD dwStreamID,
_COM_Outptr_ IMFAttributes** ppAttributes,
);

and the following parameters “dwStreamId [_In_]” which is a stream ID of the output stream whose state is to be retrieved; and “ppAttributes [_COM_Outptr_]” which receives a pointer to the “IMFAttributes” interface. The caller releases the interface.

The method returns an HRESULT. Possible values include but not limited to values given in the following table.

| Return code | Description |
|---|---|
| S_OK | Transitioning the stream state |
| | succeeded |
| MF_E_INVALIDREQUEST | Device MFT couldn't support |
| | the request at this time. |
| MF_E_INVALIDSTREAMNUMBER | When an invalid stream ID |
| | is passed |

This function is used by the device transform manager 208 to get a specific output stream's attribute store.

IMFDeviceTransform::GetStreamCount Method

This method gets a current number of input and output streams on the transform and has the following syntax:

HRESULT GetStreamCount(

_Out_ DWORD* pcInputStreams,
_Out_ DWORD* pcOutputStreams,
);

and the following parameters: “pcInputStreams [_Out_]” which receives the number of input streams; and “pcOutputStreams [_Out_]” which receives a number of output streams.

The method returns an HRESULT. Possible values include but not limited to values given in the following table.

| Return code | Description |
|---|---|
| S_OK | Transitioning the stream state succeeded |
| E_POINTER | Invalid pointer passed. |

This function is used by the device transform manager 208 to get the number of streams supported by the Device MFT. The number of streams include unselected streams—that is, streams with no media type or a NULL media type. This method is not called with NULL parameters.

IMFDeviceTransform::GetStreamIDs Method

This method gets the stream identifiers for the input and output streams on this transform and has the following syntax:

HRESULT GetStreamIDs(

_In_ DWORD dwInputStreamIDArraySize,
_Out_ DWORD* pdwInputStreamIDs,
_Out_ DWORD dwOutputStreamIDArraySize,
_Out_ DWORD* pdwOutputStreamIDs,
);

and the following parameters: “dwInputStreamIDArraySize [_In_]” which is a number of elements in “pdwInputStreamIDs;” “pdwInputStreamIDs [_Out_]” which is a pointer to an array allocated by the caller, the method fills the array with the input stream identifiers and the array size is at least equal to the number of input streams, to get the number of input streams, call “IMFDeviceTransform::GetStreamCount.” If the caller passes an array that is larger than the number of input streams, the transform does not write values into the extra array entries. The parameters also include “dwOutputStreamIDArraySize [_In_]” which is a number of elements in “pdwOutputStreamIDs” and “pdwOutputStreamIDs [_Out_]” which is a pointer to an array allocated by the caller. The method fills the array with the output stream identifiers. The array size is at least equal to the number of output streams. To get the number of output streams, call “IMFDeviceTransform::GetStreamCount.” If the caller passes an array that is larger than the number of input streams, the transform does not write values into the extra array entries.

The method returns an HRESULT. Possible values include but not limited to values given in the following table.

| Return code | Description |
|---|---|
| S_OK | Transitioning the stream state |
| | succeeded |
| E_POINTER | Invalid pointer passed. |
| MF_E_BUFFERTOOSMALL | The buffer coming in doesn't have |
| | enough space to fill in the stream IDs. |

Stream identifiers are used because some transforms can add or remove streams, so the index of a stream may not be unique. Therefore, “IMFDeviceTransform” methods that operate on streams take stream identifiers.

All input stream identifiers are unique within a transform, and all output stream identifiers are unique. However, an input stream and an output stream can share the same identifier.

If the client adds an input stream, the client assigns the identifier, so the transform allows arbitrary identifiers, as long as they are unique. If the transform creates an output stream, the transform assigns the identifier. By convention, if a transform has exactly one fixed input stream and one fixed output stream, it assigns the identifier “0” to both streams.

IMFDeviceTransform::ProcessEvent Method

This method sends an event to an input stream on transform and has the following syntax:

HRESULT ProcessEvent(

_In_ DWORD dwStreamID,
_In_ IMFMediaEvent* pEvent,
);

and the following parameters “dwStreamID [_In_]” which is a stream identifier, to get the list of stream identifiers, call “IMFDeviceTransform::GetStreamIDs;” and “pEvent [_In_]” which is a pointer to the IMFMediaEvent interface of an event object.

The method returns an HRESULT. Possible values include but not limited to values given in the following table.

| Return code | Description |
|---|---|
| S_OK | The event processed |
| | successfully. The |
| | event will be |
| | propagated down stream. |
| MF_E_INVALIDSTREAMNUMBER | Invalid stream ID passed. |
| MF_S_TRANSFORM_DO_NO_PROPOGATE_EVENT | Indicates that the |
| | Device MFT doesn't |
| | want the event to be |
| | propagated further. |
| E_NOTIMPL | Function is not |
| | implemented. |

A transform can handle sending the event downstream, or it can let the DTM do this, as indicated by the return value:
E_NOTIMPL: The transform ignores all events, and the device transform manager 208 sends all events downstream. After the pipeline receives this return value.
S_OK: The transform has examined this event, but the device transform manager 208 sends the event downstream. Internally, the MFT might respond to the event in some way, or it might ignore the event.
MF_S_TRANSFORM_DO_NOT_PROPAGATE_EVENT: The device transform manager 208 does not propagate this event downstream. Either the transform will send the event downstream, or else the transform will consume the event and not send it downstream. The transform should only consume the event if the event should stop at this transform and not travel any further downstream. But in most cases, the event should travel downstream.

To send the event downstream, the transform adds the event to the collection object that is provided by the client in the “pEvents” member of the “MFT_OUTPUT_DATA_BUFFER” structure, when the client calls IMFTransform::ProcessOutput.

Events are serialized with the samples that come before and after them. The event is attached to the output sample that follows the event, e.g., the pipeline will process the event first, and then the sample. If a transform holds back one or more samples between calls to “IMFTransform::ProcessInput” and “ProcessOutput,” the transform handles sending all events downstream, because in this situation the pipeline cannot correlate input samples with output samples. If a transform does not hold back samples and does not need to examine any events, it can return “E_NOTIMPL.”

IMFDeviceTransform::ProcessInput Method

This method delivers data to an input stream on the transform and has the following syntax:

HRESULT ProcessInput(

_In_ DWORD dwStreamID,
_In_ IMFSample *pSample,
_In_ DWORD dwFlags
);

and the following parameters: “dwStreamId [_In_]” which is the input stream identifier; “pSample[_In_]” which is a pointer to the “IMFSample” interface of the input sample, the sample contains at least one media buffer that contains valid input data; and “dwFlags [_In_]” which is zero.

The method returns an HRESULT. Possible values include but not limited to values given in the following table.

| Return code | Description |
|---|---|
| S_OK | Method succeeded |
| E_INVALIDARG | Invalid argument passed |
| MF_E_INVALIDREQUEST | Device MFT couldn't |
| | support the |
| | request at this time. |
| MF_E_INVALIDSTREAMNUMBER | When an invalid stream ID |
| | is passed |
| MF_E_INVALID_STREAM_STATE | When the requested |
| | stream transition |
| | is not possible. |
| MF_E_TRANSFORM_TYPE_NOT_SET | Input mediatype has |
| | not been set yet. |

If the method succeeds, the transform stores the sample and holds a reference count on the “IMFSample” pointer. When the transform is done using the sample it is released to avoid memory leak.

After the device transform manager 208 has set valid media types on each of the streams, the transform is able to accept more input and be able to produce more output. If a transform encounters a non-fatal error in the input data, it drops the data and attempts to recover when it gets the more input data. If the transform drops any data, it sets the “MFSampleExtension_Discontinuity” attribute on the next output sample, to notify the caller that there is a gap in the data stream.

IMFDeviceTransform::ProcessMessage Method

This method is used to send a message to the transform and has the following syntax:

HRESULT ProcessMessage(

_In_ MFT_MESSAGE_TYPE eMessage,
_In_ ULONG_PTR ulParam
);

and the following parameters “eMessage [_In_]” which is the message to send, specified as a member of the MFT_MESSAGE_TYPE enumeration; and “ulParam[_In_]” which is a message parameter. The meaning of this parameter depends on the message type.

The method returns an HRESULT. Possible values include but not limited to values given in the following table.

| Return code | Description |
|---|---|
| S_OK | Method succeeded |
| E_INVALIDARG | Invalid argument passed |
| MF_E_INVALIDREQUEST | Device MFT couldn't |
| | support the |
| | request at this time. |
| MF_E_INVALIDSTREAMNUMBER | When an invalid stream ID |
| | is passed |
| MF_E_INVALID_STREAM_STATE | When the requested |
| | stream transition |
| | is not possible. |
| MF_E_TRANSFORM_TYPE_NOT_SET | Input mediatype |
| | has not been set yet. |

Before calling this method, the media types are set on all input and output streams. The transform might ignore certain message types. If so, the method returns “S_OK.” An error code indicates that the transform handles this message type but was unable to process the message in this instance.

IMFDeviceTransform::ProcessOutput Method

This method gets the processed output from the device MFT's 306 output streams and has the following syntax:

HRESULT ProcessOutput(

_In_ DWORD dwFlags,
_In_ DWORD cOutputBufferCount,
_In_ MFT_OUTPUT_DATA_BUFFER *pOutputSamples,
_In_ DWORD* pdwStatus
);

and the following parameters: “dwFlags [_In_]” which is a bitwise OR of zero or more flags from the “MFT_PROCESS_OUTPUT_FLAGS” enumeration; “cOutputBufferCount[_In_]” which is a number of elements in the pOutputSamples array, the value is at least 1; “pOutputSamples [_Inout_]” which is a pointer to an array of “MFT_OUTPUT_DATA_BUFFER” structures, allocated by the caller, the transform uses this array to return output data to the caller; and “pdwStatus [_Out_]” which receives a bitwise OR of zero or more flags from the “MFT_PROCESS_OUTPUT_STATUS” enumeration.

The method returns an HRESULT. Possible values include but not limited to values given in the following table.

| Return code | Description |
|---|---|
| S_OK | Method succeeded |
| E_INVALIDARG | Invalid argument passed |
| MF_E_INVALIDREQUEST | Device MFT couldn't |
| | support the |
| | request at this time. |
| MF_E_INVALIDSTREAMNUMBER | When an invalid stream ID |
| | is passed |
| MF_E_INVALID_STREAM_STATE | When the requested |
| | stream transition |
| | is not possible. |
| MF_E_TRANSFORM_TYPE_NOT_SET | Input media |
| | type has not been set yet. |

If the method succeeds, the transform stores the sample and holds a reference count on the “IMFSample” pointer. When the transform is done using the sample it is released it to avoid memory leak.

After the device transform manager 208 has set valid media types on each of the streams, the transform is able to accept more input and produce more output. If a transform encounters a non-fatal error in the input data, it drops the data and attempts to recover it when it gets more input data. If the transform drops any data, it sets the “MFSampleExtension_Discontinuity” attribute on the next output sample, to notify the caller that there is a gap in the data stream.

IMFDeviceTransform::SetInputStreamState

This method is used to set the device MFT's 306 input stream state and media type and has the following syntax:

HRESULT SetInputStreamState(

_In_ DWORD dwStreamID,
_In_ IMFMediaType *pMediaType,
_In_ DeviceStreamState deviceStreamState,
_In_ DWORD dwStatus
);

and the following parameters: “dwStreamId [_In_]” which is a stream ID of an input stream whose state and mediat ype is to be changed; “pMediaType [_In_]” which is a preferred media type for the input stream that is passed through this parameter, device MFT 306 changes the media type if the incoming media type is different from the current media type; “deviceStreamState [_In_]” which specifies the desired “DeviceStreamState” to which the input stream is to transition; and “dwStatus [_In_]” which when this is “S_OK,” the state change operation is performed. Otherwise this contains an error that occurred while setting the media type on the devproxy 304 output pin. In this case, the error is propagated appropriately.

The method returns an HRESULT. Possible values include but not limited to values given in the following table.

| Return code | Description |
|---|---|
| S_OK | Transitioning the input stream |
| | state succeeded |
| MF_E_INVALIDREQUEST | Device MFT couldn't support |
| | the request at this time. |
| MF_E_INVALIDSTREAMNUMBER | When an invalid stream ID |
| | is passed |
| MF_E_INVALID_STREAM_STATE | When the requested stream |
| | transition is not possible. |

This interface helps to transition the input stream to a specified state with specified media type set on the input stream. This is used by the device transform manager 208 when the device MFT 306 requests a specific input stream's state and media type to be changed. Device MFT 306 requests such change when one of the device MFTs 306 output changes.

For example, a device MFT 306 may have two input streams and three output streams. Output 1 and Output 2 are sourcing from Input 1 and are streaming at 720p. If Output 2's media type changes to 1080p, device MFT 306 changes the Input 1 mediatype to 1080p by requesting the device transform manager 208 DTM to this function call using “METransformInputStreamStateChanged message.”

IMFDeviceTransform::GetInputStreamState

This method is used to get the Device MFT's 306 input stream state and has the following syntax:

HRESULT GetInputStreamState(

_In_ DWORD dwStreamID,
_Out_ DeviceStreamState* deviceStreamState,
);

and the following parameters: “dwStreamId [_In_]” which is a stream ID of an input stream whose state is to be retrieved; and “deviceStreamState [_Out_]” which specifies a current “DeviceStreamState” of the specified input Device MFT stream.

The method returns an HRESULT. Possible values include but not limited to values given in the following table.

| Return code | Description |
|---|---|
| S_OK | Transitioning the stream state |
| | succeeded |
| MF_E_INVALIDREQUEST | Device MFT couldn't support |
| | the request at this time. |
| MF_E_INVALIDSTREAMNUMBER | When an invalid stream ID is |
| | passed |

This function is used by the device transform manager 208 to get a specific input stream's state.

IMFDeviceTransform::SetOutputStreamState

This method sets the Device MFT's 306 output stream state and media type and has the following syntax:”

HRESULT SetOutputStreamState(

_In_ DWORD dwStreamID,
_In_ IMFMediaType *pMediaType,
_In_ DeviceStreamState deviceStreamState,
_In_ DWORD dwFlags
);

and the following parameters: “dwStreamId [_In_]” which is a stream ID of the output stream whose state and media type is to be changed; “pMediaType [_In_]” which is a preferred media type for the output stream that is passed in through this parameter, device MFT 306 changes the media type if the incoming media type is different from the current media type as before; “deviceStreamState [_In_]” which specifies a desired “DeviceStreamState” to which the output stream is to transition; and “dwFlags [_In_]” which is zero.

The method returns an HRESULT. Possible values include but not limited to values given in the following table.

| Return code | Description |
|---|---|
| S_OK | Transitioning the stream state |
| | succeeded |
| MF_E_INVALIDREQUEST | Device MFT couldn't support |
| | the request at this time. |
| MF_E_INVALIDSTREAMNUMBER | When an invalid stream ID |
| | is passed |
| MF_E_INVALID_STREAM_STATE | When the requested stream |
| | transition is not possible. |

This interface function helps to transition an output stream to a specified state with specified media type set on the output stream. This is used by the device transform manager 208 when the device source 302 requests change of a specific output stream's state and media type. Device MFT 306 changes the specified output stream's media type and state to the requested media type.

If the incoming media type and stream state are same as the current media type and stream state then just return “S_OK.” If the incoming media type and current media type of the stream are the same, device MFT 306 changes the stream's state to the requested value and returns the appropriate HRESULT.

When a change in the output stream's media type has a corresponding change in the input then device MFT 306 posts “METransformInputStreamStateChanged” to the transform to change the relevant input stream. The call returns after changing the input stream's media type and the appropriate HRESULT.

For example, consider a device MFT 306 that has two input streams and three output streams and Output 1 and Output 2 are sourcing from Input 1 and are streaming at 720p. If Output 2's media type changes to 1080p, the device MFT 306 changes the Input 1 media type to 1080p, by posting “METransformInputStreamStateChanged” event to the device transform manager 208. The device transform manager 208 calls “SetInputStreamState” to change the input stream media type and state. After this call, the “SetOutputStreamState” returns.

IMFDeviceTransform::GetOutputStreamState

This method gets the Device MFT's 306 output stream state and has the following syntax:

HRESULT GetOutputStreamState(

_In_ DWORD dwStreamID,
_Out_ DeviceStreamState* deviceStreamState,
);

and the following parameters: “dwStreamId [_In_]” which is a stream ID of the output stream whose state is to be retrieved; and “deviceStreamState [_Out_]” which specifies a current “DeviceStreamState” of the specified output device MFT 306 stream.

The method returns an HRESULT. Possible values include but not limited to values given in the following table.

| Return code | Description |
|---|---|
| S_OK | Transitioning the stream state |
| | succeeded |
| MF_E_INVALIDREQUEST | Device MFT couldn't support |
| | the request at this time. |
| MF_E_INVALIDSTREAMNUMBER | When an invalid stream ID |
| | is passed |

This function is used by the device transform manager 208 to get a specific output stream's state.

IMFDeviceTransform::GetInputStreamPreferredState

This method gets a device MFT 306 input stream's preferred state and media type and has the following syntax:

HRESULT GetInputStreamPreferredState(

_In_ DWORD dwStreamID,
_Out_ DeviceStreamState* deviceStreamState,
_COM_Outptr_ IMFMediaType** ppMediaType,
);

and the following parameters: “dwStreamId [_In_]” which is a stream ID of the input stream whose preferred state and media type is to be retrieved; a “deviceStreamState [_Out_]” which specifies a desired “DeviceStreamState” for a specific Device MFT's 306 input stream; and “ppMediaType [_COM_Outptr_]” which is a preferred media type for the input stream is passed in through this parameter.

The method returns an HRESULT. Possible values include but not limited to values given in the following table.

| Return code | Description |
|---|---|
| S_OK | Transitioning the stream state |
| | succeeded |
| MF_E_INVALIDREQUEST | Device MFT couldn't support |
| | the request at this time. |
| MF_E_INVALIDSTREAMNUMBER | When an invalid stream ID |
| | is passed |
| MF_E_INVALID_STREAM_STATE | When the requested stream |
| | transition is not possible. |

This interface function helps to query the device MFT 306 input stream's preferred state and media type to which it is to be transitioned.

When a change in the output stream's media type has a corresponding change in the input, then device MFT 306 posts “METransformInputStreamStateChanged” to the device transform manager 208 to change the relevant input stream. The device transform manager 208 calls “GetInputStreamPreferredState” to retrieve the device MFT 306 input stream's preferred media type and state.

For example, consider a device MFT 306 that has two input streams and three output streams and Output 1 and Output 2 are sourcing from Input 1 and are streaming at 720p. If Output 2's media type changes to 1080p, the device MFT 306 changes the Input 1 media type to 1080p, by posting “METransformInputStreamStateChanged” event to the device transform manager 208. The device transform manager 208 calls “GetInputStreamPreferredState” and retrieves the preferred state and media type. The device transform manager 208 calls “SetInputStreamState” to change the input stream′ media type and state.

IMFDeviceTransform::FlushInputStream Method

This method flushes a device MFT's 306 input stream and has the following syntax:

HRESULT FlushInputStream (

_In_ DWORD dwStreamID,
_In_ DWORD dwStatus
);

and the following parameters “dwStreamId [_In_]” which is a stream ID of the input stream which is to be flushed; and “dwStatus [_In_]” will contain HRESULT of the flushing the corresponding devproxy output stream.

The method returns an HRESULT. Possible values include but not limited to values given in the following table.

| Return code | Description |
|---|---|
| S_OK | Transitioning the stream state |
| | succeeded |
| MF_E_INVALIDREQUEST | Device MFT couldn't support |
| | the request at this time. |
| MF_E_INVALIDSTREAMNUMBER | When an invalid stream ID |
| | is passed |
| MF_E_INVALID_STREAM_STATE | When the requested stream |
| | transition is not possible. |

This interface function helps to flush a device MFT's 306 input stream. Device MFT 306 drops samples in its queues and resets its internal data structures related to that input stream. This is equivalent to resetting the input stream. The media type and stream state do not change. This is called when the input stream is to be reset, and the device transform manager 208 calls this function.

IMFDeviceTransform::FlushOutputStream Method

This method flushes a device MFT's 306 input stream and has the following syntax:

HRESULT FlushOutputStream (

_In_ DWORD dwStreamID,
_In_ DWORD dwFlags
);

and the following parameters: “dwStreamId [_In_]” which is a stream ID of the output stream which is to be flushed; and “dwFlags [_In_]” which is zero.

The method returns an HRESULT. Possible values include but not limited to values given in the following table.

| Return code | Description |
|---|---|
| S_OK | Transitioning the stream state |
| | succeeded |
| MF_E_INVALIDREQUEST | Device MFT couldn't support |
| | the request at this time. |
| MF_E_INVALIDSTREAMNUMBER | When an invalid stream ID |
| | is passed |
| MF_E_INVALID_STREAM_STATE | When the requested stream |
| | transition is not possible. |

This interface function helps to flush a device MFT's 306 input stream. The device MFT 306 drops all samples in its queues and resets its internal data structures related to that input stream. This is equivalent to resetting the input stream. The media type and stream state does not change. When the output stream is to be reset, the device transform manager 208 calls this function.

Device MFT 306 Interface Features

Device MFTs 306 support the following interfaces:

1. IMFDeviceTransform;

2. IksControl;

3. IMFRealtimeClientEx; and

4. IMFShutdown.

Device MFTs 306 use the following messages to inform the device transform manager 208 about the availability of samples, any input stream state change and so on:

1. METransformHaveOutput;

2. METransformInputStreamStateChanged; and

3. METransformFlushInputStream.

The Device MFT 306 does not create its own threads. Instead it uses work queues, whose ID is passed through the “IMFRealtimeClientEx” interface. This is to make sure that all the threads running in the device MFT 306 get the correct priority at which the capture pipeline 208 is running Otherwise it may cause thread priority inversions.

Input Stream Features

The number of input streams to the device MFT 306 is the same as the number of streams supported by the device driver 120. The number of media types and the actual media types supported by the device MFT's 306 inputs match the number and types of media types supported by the device driver 120. Additionally, the number may be different only if the media types supported by the input of Device MFT is a subset of the media types supported by the driver. The media types supported by the device driver 120 and input of device MFT 306 could be standard or custom media types.

### Example Procedures

The following discussion describes user mode driver extension and preprocessing techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. In portions of the following discussion, reference will be made to the figures described above.

Functionality, features, and concepts described in relation to the examples of FIGS. 1-6 may be employed in the context of the procedures described herein. Further, functionality, features, and concepts described in relation to different procedures below may be interchanged among the different procedures and are not limited to implementation in the context of an individual procedure. Moreover, blocks associated with different representative procedures and corresponding figures herein may be applied together and/or combined in different ways. Thus, individual functionality, features, and concepts described in relation to different example environments, devices, components, and procedures herein may be used in any suitable combinations and are not limited to the particular combinations represented by the enumerated examples.

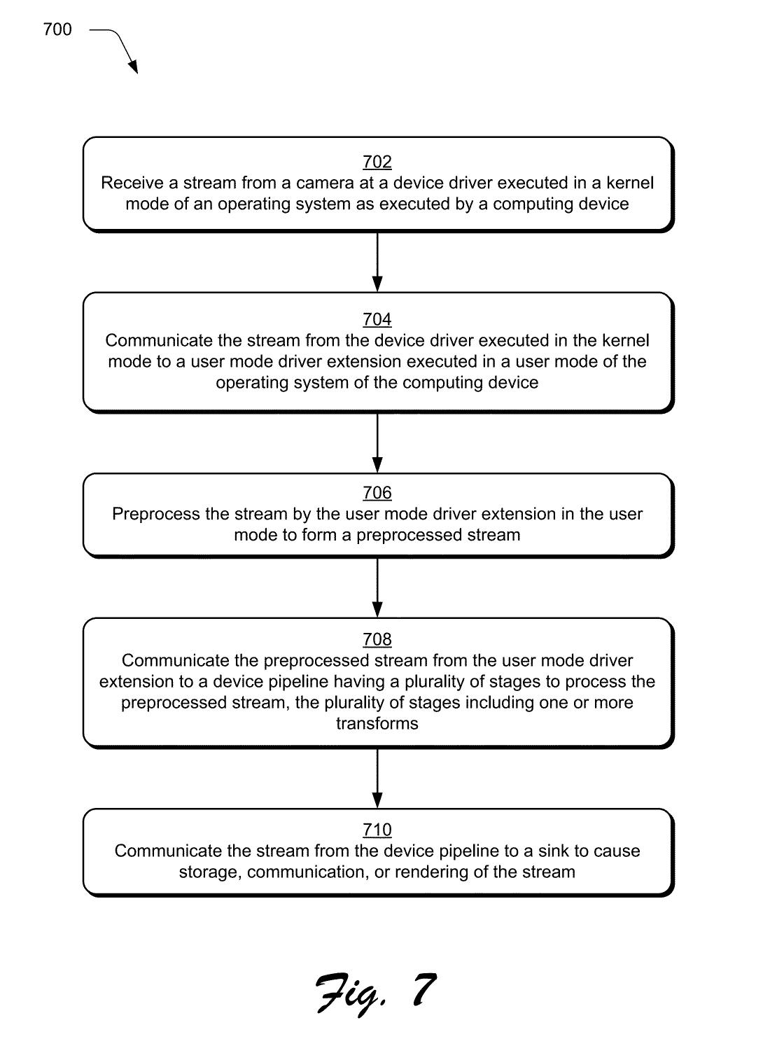

FIG. 7 depicts a procedure 700 in an example implementation in which user mode driver extension and processing techniques are described. A stream is received from a camera at a device driver executed in a kernel mode of an operating system as executed by a computing device (block 702). The stream, for instance, may include video, images, and so forth. Non-camera examples are also contemplated.

The stream is communicated from the device driver executed in the kernel mode to a user mode driver extension executed in a user mode of the operating system of the computing device (block 704). The device driver 120, for instance, is executed in the kernel mode 116 of the operating system. On the other hand, the user mode drive extension 122 is executed in the user mode 118 of the operating system 114.

The stream is preprocessed by the user mode driver extension in the user mode to form a preprocessed stream (block 706). A variety of different preprocessing techniques may be employed, such as black level correction, dead pixel correction, demosaicing, color correction, lens correction, noise reduction, face recognition, object recognition, scaling or color conversion.

The preprocessed stream is communicated from the user mode driver extension to a device pipeline having a plurality of stages to process the preprocessed stream, the plurality of stages including one or more transforms (block 708). In this way, the user mode drive extension 122 is abstracted away from the pipeline 208. The stream is communicated from the device pipeline to a sink to cause storage, communication, or rendering of the stream (block 710), such as for storage, rendering, communication via a network, and so forth.

### Example System and Device

FIG. 8 illustrates an example system generally at 800 that includes an example computing device 802 that is representative of one or more computing systems and/or devices that may implement the various techniques described herein, as shown through inclusion of the operating system 114, device driver 120, and user mode driver extension 122. The computing device 802 may be, for example, a server of a service provider, a device associated with a client (e.g., a client device), an on-chip system, and/or any other suitable computing device or computing system.

The example computing device 802 as illustrated includes a processing system 804, one or more computer-readable media 806, and one or more I/O interface 808 that are communicatively coupled, one to another. Although not shown, the computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware element 810 that may be configured as processors, functional blocks, and so forth. This may include implementation in hardware as an application specific integrated circuit or other logic device formed using one or more semiconductors. The hardware elements 810 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 806 is illustrated as including memory/storage 812. The memory/storage 812 represents memory/storage capacity associated with one or more computer-readable media. The memory/storage component 812 may include volatile media (such as random access memory (RAM)) and/or nonvolatile media (such as read only memory (ROM), Flash memory, optical disks, magnetic disks, and so forth). The memory/storage component 812 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of a module that is executable by the computing device 802 as software may be achieved at least partially in hardware, e.g., through use of computer-readable storage media and/or hardware elements 810 of the processing system 804. The instructions and/or functions may be executable/operable by one or more articles of manufacture (for example, one or more computing devices 802 and/or processing systems 804) to implement techniques, modules, and examples described herein.

As further illustrated in FIG. 8, the example system 800 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 800, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 802 may assume a variety of different configurations, such as for computer 814, mobile 816, and television 818 uses. Each of these configurations includes devices that may have generally different constructs and capabilities, and thus the computing device 802 may be configured according to one or more of the different device classes. For instance, the computing device 802 may be implemented as the computer 814 class of a device that includes a personal computer, desktop computer, a multi-screen computer, laptop computer, netbook, and so on.

The computing device 802 may also be implemented as the mobile 816 class of device that includes mobile devices, such as a mobile phone, portable music player, portable gaming device, a tablet computer, a multi-screen computer, and so on. The computing device 802 may also be implemented as the television 818 class of device that includes devices having or connected to generally larger screens in casual viewing environments. These devices include televisions, set-top boxes, gaming consoles, and so on.

The techniques described herein may be supported by these various configurations of the computing device 802 and are not limited to the specific examples of the techniques described herein. This functionality may also be implemented all or in part through use of a distributed system, such as over a “cloud” 820 via a platform 822 as described below.

The cloud 820 includes and/or is representative of a platform 822 for resources 824. The platform 822 abstracts underlying functionality of hardware (e.g., servers) and software resources of the cloud 820. The resources 824 may include applications and/or data that can be utilized while computer processing is executed on servers that are remote from the computing device 802. Resources 824 can also include services provided over the Internet and/or through a subscriber network, such as a cellular or Wi-Fi network.

The platform 822 may abstract resources and functions to connect the computing device 802 with other computing devices. The platform 822 may also serve to abstract scaling of resources to provide a corresponding level of scale to encountered demand for the resources 824 that are implemented via the platform 822. Accordingly, in an interconnected device embodiment, implementation of functionality described herein may be distributed throughout the system 800. For example, the functionality may be implemented in part on the computing device 802 as well as via the platform 822 that abstracts the functionality of the cloud 820.

### Conclusion and Example Implementations

Example implementations described herein include, but are not limited to, one or any combinations of one or more of the following examples:

In one or more examples, a computing device implements techniques that promote stability of execution of drivers performed by a computing device including stream preprocessing. The computing device includes a processing system to execute an operating system using a kernel mode and a user mode and memory configured to maintain instructions stored thereon that are executable by the processing system. The instructions include the operating system and a device driver and a user mode driver extension that correspond to a camera to support a communicative coupling between the camera and the operating system. The device driver is executable within the kernel mode and the user mode driver extension executable within the user mode. The user mode driver extension is configured to preprocess streams originated by the camera before processing by a camera pipeline of the operating system.

An example as described alone or in combination with any of the above or below examples, wherein the user mode driver extension supports concurrent processing of a plurality of streams.

An example as described alone or in combination with any of the above or below examples, wherein the user mode driver extension is configured to use parallel processing.

An example as described alone or in combination with any of the above or below examples, wherein the user mode driver extension is configured to use one or more graphics engines to perform at least a part of the post processing.

An example as described alone or in combination with any of the above or below examples, wherein the user mode driver extension is configured to accept a number of input streams that is different than a number of streams output by the user mode driver extension.

An example as described alone or in combination with any of the above or below examples, wherein the user mode driver extension has access to Image Signal Processor (ISP) resources.

An example as described alone or in combination with any of the above or below examples, wherein the user mode driver extension and the device driver are configured to perform out-of-band communication.

An example as described alone or in combination with any of the above or below examples, wherein the out-of-band communication is usable to communicate dedicated metadata or 3A processing streams.

An example as described alone or in combination with any of the above or below examples, wherein the preprocessing includes black level correction, dead pixel correction, demosaicing, color correction, lens correction, noise reduction, face recognition, or object recognition.

An example as described alone or in combination with any of the above or below examples, wherein the preprocessing includes scaling and color conversion.

An example as described alone or in combination with any of the above or below examples, wherein the user mode driver extension is configured such that in an event of a crash, the crash does not cause a crash of the device driver.

In one or more examples, a system is described of implementing techniques that promote stability of execution of drivers and including stream preprocessing. The system includes a processing system to execute an operating system using a kernel mode and a user mode and memory configured to maintain instructions stored thereon that are executable by the processing system. The instructions including the operating system having a device pipeline having a plurality of stages, one or more of which are configured to transform a stream of data originated by a device, a device driver that corresponds to the device and is executable within the kernel mode, and a user mode driver extension that is executable within the user mode and that corresponds to the device to support a communicative coupling formed along with the device driver between the camera and the device pipeline. The user mode driver extension is configured to preprocess streams originated by the camera before processing by the device pipeline.

An example as described alone or in combination with any of the above or below examples, wherein the device pipeline is part of the operating system and the device driver and user mode driver extension are provided by a manufacturer of the device.

An example as described alone or in combination with any of the above or below examples, further comprising a device transform manager to manage execution of the user mode driver extension and that represents the device to the device pipeline.

An example as described alone or in combination with any of the above or below examples, wherein the preprocessing includes black level correction, dead pixel correction, demosaicing, color correction, lens correction, noise reduction, face recognition, or object recognition.

An example as described alone or in combination with any of the above or below examples, wherein the preprocessing includes scaling and color conversion.

An example as described alone or in combination with any of the above or below examples, wherein the user mode driver extension is configured such that in an event of a crash, the crash does not cause a crash of the device driver.

In one or more examples, a method involves techniques that promote stability of execution of drivers and stream preprocessing. The method includes receiving a stream from a camera at a device driver executed in a kernel mode of an operating system as executed by a computing device, communicating the stream from the device driver executed in the kernel mode to a user mode driver extension executed in a user mode of the operating system of the computing device, preprocessing the stream by the user mode driver extension in the user mode to form a preprocessed stream, and communicating the preprocessed stream from the user mode driver extension to a device pipeline having a plurality of stages to process the preprocessed stream, the plurality of stages including one or more transforms.

An example as described alone or in combination with any of the above or below examples, wherein the preprocessing includes black level correction, dead pixel correction, demosaicing, color correction, lens correction, noise reduction, face recognition, object recognition, scaling, or color conversion.

An example as described alone or in combination with any of the above or below examples, further comprising communicating the stream from the device pipeline to a sink to cause storage, communication, or rendering of the stream.

Although the example implementations have been described in language specific to structural features and/or methodological acts, it is to be understood that the implementations defined in the appended claims is not necessarily limited to the specific features or acts described. Rather, the specific features and acts are disclosed as example forms of implementing the claimed features.

What is claimed is:

1. A computing device implements techniques that promote stability of execution of drivers performed by a computing device that includes stream preprocessing, the computing device comprising:
a processing system to execute an operating system having a kernel mode and a user mode; and
memory configured to maintain instructions stored thereon that are executable by the processing system, the instructions including the operating system and a device driver and a user mode driver extension that correspond to a device to support a communicative coupling between the device and the operating system, the device driver executable within the kernel mode and the user mode driver extension executable within the user mode, the user mode driver extension configured to preprocess streams originated by the device before processing by a camera pipeline of the operating system.

2. A computing device as described in claim 1, wherein the user mode driver extension supports concurrent processing of a plurality of streams.

3. A computing device as described in claim 1, wherein the user mode driver extension supports parallel processing.

4. A computing device as described in claim 1, wherein the user mode driver extension supports use of one or more graphics engines to perform at least a part of the preprocessing.

5. A computing device as described in claim 1, wherein the user mode driver extension is configured to accept a number of input streams that is different than a number of streams output by the user mode driver extension.

6. A computing device as described in claim 1, wherein the user mode driver extension has access to Image Signal Processor (ISP) resources.

7. A computing device as described in claim 1, wherein the user mode driver extension and the device driver are configured to perform out-of-band communication, one to another.

8. A computing device as described in claim 7, wherein the out-of-band communication is usable to communicate dedicated metadata.

9. A computing device as described in claim 1, wherein the preprocessing includes black level correction, dead pixel correction, demosaicing, color correction, lens correction, noise reduction, face recognition, or object recognition.

10. A computing device as described in claim 1, wherein the preprocessing includes scaling and color conversion.

11. A computing device as described in claim 1, wherein the user mode driver extension is configured such that in an event of a crash, the crash does not cause a crash of the device driver.

12. A system implementing techniques that promote stability of execution of drivers and including stream preprocessing, the system comprising:
a processing system to execute an operating system using a kernel mode and a user mode; and
memory configured to maintain instructions stored thereon that are executable by the processing system, the instructions including the operating system having:
a device pipeline having a plurality of stages, one or more of which are configured to transform a stream of data originated by a device;
a device driver that corresponds to the device and is executable within the kernel mode;
a user mode driver extension that is executable within the user mode and that corresponds to the device to support a communicative coupling formed along with the device driver between the camera and the device pipeline, the user mode driver extension configured to preprocess streams originated by the camera before processing by the device pipeline.

13. A system as described in claim 12, wherein the device pipeline is part of the operating system and the device driver and user mode driver extension are provided by a manufacturer of the device.

14. A system as described in claim 12, further comprising a device transform manager to manage execution of the user mode driver extension and that represents the device to the device pipeline.

15. A system as described in claim 12, wherein the preprocessing includes black level correction, dead pixel correction, demosaicing, color correction, lens correction, noise reduction, face recognition, or object recognition.

16. A system as described in claim 12, wherein the preprocessing includes scaling and color conversion.

17. A system as described in claim 12, wherein the user mode driver extension is configured such that in an event of a crash, the crash does not cause a crash of the device driver.

18. A method involving techniques that promote stability of execution of drivers and stream preprocessing, the method comprising:
receiving a stream from a camera at a device driver executed in a kernel mode of an operating system as executed by a computing device;
communicating the stream from the device driver executed in the kernel mode to a user mode driver extension executed in a user mode of the operating system of the computing device;
preprocessing the stream by the user mode driver extension in the user mode to form a preprocessed stream; and
communicating the preprocessed stream from the user mode driver extension to a device pipeline having a plurality of stages to process the preprocessed stream, the plurality of stages including one or more transforms.

19. A method as described in claim 18, wherein the preprocessing includes black level correction, dead pixel correction, demosaicing, color correction, lens correction, noise reduction, face recognition, object recognition, scaling, or color conversion.

20. A method as described in claim 18, further comprising communicating the stream from the device pipeline to a sink to cause storage, communication, or rendering of the stream.
